(19) United States
(12) Patent Application Publication
(10) Pub. No.: US 2025/0340480 A1
(43) Pub. Date: Nov. 6, 2025

(54) CRYSTALLIZED GLASS AND METHOD FOR MANUFACTURING SAME

(71) Applicant: NIPPON ELECTRIC GLASS CO., LTD., Otsu-shi, Shiga (JP)

(72) Inventors: Yusuke OKADA, Otsu-shi (JP); Yuki YOKOTA, Otsu-shi (JP)

(21) Appl. No.: 18/864,689

(22) PCT Filed: Jun. 7, 2023
(86) PCT No.: PCT/JP2023/021123

§ 371 Date: Nov. 11, 2024

(30) Foreign Application Priority Data
Jun. 13, 2022 (JP) 2022-094804

(51) Int. Cl. C03C 10/00

(52) U.S. Cl. CPC C03C 10/0027; C03C 10/0054; C03C 2203/52

(57) ABSTRACT

Provided is a crystallized glass having a desired semitransparency and capable of being easily made transparent as necessary. A crystallized glass has an average haze of more than 0 to 30% at wavelengths of 380 to 780 nm in terms of a thickness of 4 mm and has a main crystal with an average particle diameter of 1 to 100 nm.

### TECHNICAL FIELD

The present invention relates to crystallized glasses having a semitransparent appearance.

### BACKGROUND ART

Conventionally, semitransparent glass products and semitransparent glass ceramic products are used in windows, doors, and the like aimed at simultaneous pursuit of assurance of privacy and daylighting. Frosted glass, which is a type of semitransparent glass, is obtained by blasting a glass surface with sand or the like to roughen the surface and used mainly as window glass. Frosted glass is effective for assurance of privacy, but its surface roughness is significantly large, which presents a problem of easy reduction in mechanical strength and high susceptibility to breakage due to external shock and so on.

For this reason, there has heretofore been proposed as a semitransparent glass, a crystallized glass in which coarse crystals are precipitated in the glass. For example, in Patent Literature 1, a Li₂O—Al₂O₃—SiO₂-based glass is subjected to heat treatment at high temperature to crystallize it and thus precipitate a β-spodumene solid solution having an average particle diameter of 150 nm or more in the glass matrix, resulting in achievement of semitransparence.

Likewise, Patent Literature 2 also shows that the optical transparency changes by the size and type of precipitated crystals. This Patent Literature describes that a semitransparent or opaque colored crystallized glass can be produced by precipitating a β-spodumene solid solution (keatite) having an average particle diameter of more than 100 nm. Specifically, the literature describes that a more semitransparent glass ceramic can be produced by reducing the content of nucleating components and increasing the crystal size.

### CITATION LIST

### Patent Literature

[PTL 1]
JP-A-2003-300752
[PTL 2]
JP-A-2005-325018

### SUMMARY OF INVENTION

### Technical Problem

The method of excessively growing crystals under high-temperature conditions, like Patent Literature 1, is not preferable from the viewpoint of energy consumption and has a problem in that the damage to a firing furnace due to high-temperature firing is large. In addition, the crystal growth process as described above irreversibly progresses and, therefore, it is fundamentally impossible to return a glass once crystallized and made semitransparent to a transparent state.

It is possible to produce a semitransparent crystallized glass by changing the composition, like Patent Literature 2. However, a dense crystalline phase is less likely to be formed from a glass containing a significantly small amount of nucleating components and, therefore, it is difficult to obtain a transparent crystallized glass by changing the firing conditions from the same composition.

An object of the present invention is to provide a crystallized glass having a desired semitransparency and capable of being easily made transparent as necessary.

### Solution to Problem

A crystallized glass according to the present invention has an average haze of more than 0 to 30% at wavelengths of 380 to 780 nm in terms of a thickness of 4 mm and has a main crystal with an average particle diameter of 1 to 100 nm.

Crystals in the crystallized glass tend to increase the light scattering intensity with increasing size. Furthermore, the light scattering intensity tends to increase with increasing refractive index difference between crystals and the surrounding glass phase. For example, as described previously, a semitransparent product of a conventional Li₂O—Al₂O₃—SiO₂ crystallized glass ensures its semitransparency by precipitating therein a β-spodumene solid solution having a large crystal size and a different refractive index from the glass phase. However, the process of precipitation of the β-spodumene solid solution having a large crystal size is irreversible and, therefore, it is difficult to return the product once made semitransparent to a transparent product.

The inventors conducted intensive studies and, as a result, found a crystallized glass having achieved semitransparency by precipitating crystals of a smaller size than in the conventional semitransparent product. As will be described hereinafter, this crystallized glass can be produced by controlling the heat treatment temperature during crystallization. The detailed mechanism of this is under investigation, but it can be considered as follows.

In subjecting an amorphous precursor glass to heat treatment to crystallize it, the refractive index difference between crystals and the remaining glass phase changes over a period from an initial stage of crystallization to a termination stage of crystallization. Specifically, the refractive index difference between crystals and the glass phase is large in the initial stage of crystallization and decreases with the progress of crystallization. In view of this, by controlling the heat treatment temperature during crystallization to stop the crystallization in the initial stage of crystallization, the refractive index difference between crystals and the remaining glass phase remains large and a semitransparent appearance of the glass can be obtained due to this refractive index difference. Although in the initial stage of crystallization the average particle diameter of crystals is as small as 1 to 100 nm, the average particle diameter of crystals undergoes little change even after the heat treatment is further conducted as it is to progress the crystallization to a certain extent. Meanwhile, the refractive index difference between crystals and the glass phase becomes gradually smaller (and eventually approximates zero or reaches zero) and, therefore, the crystallized glass can be made transparent. As just described, the crystallized glass according to the present invention can be easily made transparent from a semitransparent state by subjecting it to further heat treatment.

Herein, the term “average haze” refers to an arithmetic average value of hazes determined, using the following equation, in terms of total light transmittance and diffused transmittance of glass at predetermined wavelengths measured using an integrating sphere.

$$Haze = ( Diffused Transmittance ) / ( Total Light Transmittance )$$

The crystallized glass according to the present invention preferably contains the following components in terms of % by mass. By doing so, a desired semitransparent crystallized glass can be easily obtained.
SiO₂: 45 to 75%,
Al₂O₃: 15 to 35%,
Li₂O: 0 to 4%,
Na₂O: 0 to 6%,
K₂O: 0 to 10%,
TiO₂: 0 to 1.4%,
SnO₂: 0 to 3%,
P₂O₅: 0 to 2%,
ZrO₂: 0.5% or more, and
P₂O₅/(ZrO₂+TiO₂)≤0.4.

Herein, “x+y+ . . . ” means the total of contents of the components. Furthermore, “x/y” means a value obtained by dividing the content of x by the content of y.

In the crystallized glass according to the present invention, a value of β-OH [mm⁻¹] and a total content of ZrO₂ and TiO₂ in terms of % by mass preferably satisfy β-OH/(ZrO₂+TiO₂)≤0.14. By doing so, a dense crystalline phase can be easily obtained. The term “β-OH/(ZrO₂+TiO₂)” used herein means a value obtained by dividing the value of β-OH by the total content of ZrO₂ and TiO₂. β-OH refers to a value obtained by measuring transmittances of glass with an FT-IR (Fourier transform infrared spectrophotometer) and determining from the transmittances using the following equation.

$$β - OH = ( 1 / X ) log ( {T}_{1} / {T}_{2} )$$

X: glass thickness (mm)
T₁: transmittance (%) at a reference wavelength of 3846 cm⁻¹
T₂: minimum transmittance (%) at a hydroxyl group absorption wavelength of around 3600 cm⁻¹

In the crystallized glass according to the present invention, Pt+Rh is preferably less than 7 ppm.

In the crystallized glass according to the present invention, the content of MoO₃ is preferably more than 0%.

The crystallized glass according to the present invention is preferably substantially free of As component and Pb component. As used herein, “substantially free of” means that relevant components are not deliberately incorporated as raw materials into the glass and does not mean to exclude unavoidable impurities. Objectively, this means that the content of relevant components is not more than 0.1% in terms of % by mass.

The crystallized glass according to the present invention preferably has a crystallinity of 1 to 99%.

In the crystallized glass according to the present invention, at least one selected from among a β-quartz solid solution, a β-spodumene solid solution, and zirconia is preferably precipitated.

A method for manufacturing a crystallized glass according to the present invention is a method for manufacturing the above-described crystallized glass and includes the steps of: preparing a precursor glass; and subjecting the precursor glass to heat treatment at a temperature of not more than +200° C. relative to a glass transition point of the precursor glass to crystallize the precursor glass. The glass transition point means the temperature at a point (an inflection point) where the slope of the thermal expansion curve of glass changes.

### Advantageous Effects of Invention

The present invention enables provision of a crystallized glass having a desired semitransparency and capable of being easily made transparent as necessary.

### BRIEF DESCRIPTION OF DRAWINGS

FIG. 1 is a photograph of a crystallized glass sample obtained in No. 3 of an example.

### DESCRIPTION OF EMBODIMENTS

A crystallized glass according to the present invention has an average haze of more than 0 to 30% at wavelengths of 380 to 780 nm in terms of a thickness of 4 mm and has a main crystal with an average particle diameter of 1 to 100 nm.

The larger the average particle diameter of the main crystal is, the more likely the crystallized glass is to have a semitransparent appearance. Therefore, the average particle diameter of the main crystal is preferably not less than 1 nm, not less than 5 nm, not less than 10 nm, or not less than 20 nm, and particularly preferably not less than 30 nm. On the other hand, there may be a case where the average particle diameter of the main crystal is excessively large. Even if, in this case, crystallization is progressed by a further heat treatment process to reduce the refractive index difference between the crystalline phase and the glass phase, the light scattering intensity at the interface between both the phases is not sufficiently reduced and it is difficult to return the glass to a transparent product. In terms of this viewpoint, the smaller the average particle diameter of the main crystal, the better. Specifically, the average particle diameter thereof is preferably not more than 100 nm, not more than 90 nm, not more than 80 nm, not more than 70 nm, or not more than 60 nm, and particularly preferably not more than 50 nm.

Meanwhile, as the content of crystals in the crystallized glass is larger, the interface between the crystalline phase and the glass phase becomes larger, light scattering is more likely to occur, and therefore the glass is more likely to be semitransparent. For this reason, in order to obtain a desired semitransparency, the crystallinity is preferably not less than 1%, not less than 5%, not less than 10%, not less than 20%, or not less than 30%, and particularly preferably not less than 40%. On the other hand, if the crystallinity is too high, the refractive index difference between the crystalline phase and the glass phase tends to become small and, therefore, a desired semitransparency may not be able to be obtained also in this case. In terms of this viewpoint, the lower the crystallinity, the better. Specifically, the crystallinity is preferably not more than 99%, not more than 95%, not more than 90%, not more than 85%, not more than 80%, not more than 75%, or not more than 70%, and particularly preferably not more than 60%.

Examples of the type of main crystal include, as for Li₂O—Al₂O₃—SiO₂ crystallized glass, Li₂O—Al₂O₃—SiO₂-based crystals, such as β-quartz solid solution and β-spodumene solid solution, and zirconia. A single type of crystals may be precipitated or two or more types of crystals may be precipitated. β-quartz solid solution and β-spodumene solid solution have a relatively small refractive index difference from the glass phase. Therefore, by progressing the crystallization based on the above-described mechanism, it is possible to change a semitransparent product into a transparent product. Meanwhile, the particle diameter of β-spodumene solid solution is likely to become large due to the stability of the crystals themselves. Therefore, a crystallized glass containing β-spodumene solid solution is likely to be a semitransparent product. However, for the reason described previously, if β-spodumene solid solution is excessively precipitated, it is difficult to return the glass to the transparent product by the subsequent heat treatment. Therefore, as for Li₂O—Al₂O₃—SiO₂-based crystallized glass, the main crystal is preferably a β-quartz solid solution. Zirconia has the effect of promoting dense precipitation of other types of crystals and, therefore, a crystallized glass having a homogeneous appearance can be easily obtained.

If the haze of the crystallized glass is too low, the transparency becomes high, which makes it difficult to obtain a desired semitransparent appearance. Therefore, the average haze of the crystallized glass according to the present invention at wavelengths of 380 to 780 nm is, in terms of a thickness of 4 mm, preferably more than 0%, not less than 0.1%, not less than 0.2%, not less than 0.3%, not less than 0.4%, not less than 0.5%, more than 0.5%, not less than 0.6%, not less than 0.7%, not less than 0.8%, not less than 0.9%, not less than 1%, not less than 2%, not less than 3%, not less than 5%, or not less than 10%, and particularly preferably not less than 15%. On the other hand, if the haze of the crystallized glass is excessively high, the transmittance becomes excessively low. Therefore, for example, when the crystallized glass is used as a window glass, its daylighting performance tends to be lost. For this reason, the average haze is preferably not more than 30%, more preferably not more than 28%, and particularly preferably not more than 25%.

Next, a description will be given of a preferred example of the composition of the crystallized glass according to the present invention. The crystallized glass according to the present invention preferably contains the following components in terms of % by mass. Reasons why the composition is limited as follows will be described hereafter. In the following description, “%” and “ppm” are in terms of “% by mass” unless otherwise stated.
SiO₂: 45 to 75%,
Al₂O₃: 15 to 35%,
Li₂O: 0 to 4%,
Na₂O: 0 to 6%,
K₂O: 0 to 10%,
TiO₂: 0 to 1.4%,
SnO₂: 0 to 3%,
P₂O₅: 0 to 2%,
ZrO₂: 0.5% or more, and
P₂O₅/(ZrO₂+TiO₂)≤0.4.

SiO₂ is a component that forms part of a glass network. The content of SiO₂ is preferably 45 to 75%, 50 to 75%, 55 to 70%, or 60 to 70%, and particularly preferably 65 to 70%. If the content of SiO₂ is too small, the coefficient of thermal expansion tends to increase and, therefore, a crystallized glass having excellent thermal shock resistance is less likely to be obtained. In addition, the chemical durability tends to decrease. On the other hand, if the content of SiO₂ is too large, the meltability of glass decreases and the viscosity of glass melt increases, which makes it difficult to clarify the glass and difficult to form the glass into shape and, therefore, makes it likely that the productivity decreases. In addition, the time required for crystallization becomes long and, therefore, the productivity is likely to decrease.

Al₂O₃ is a component that forms part of a glass network. In addition, Al₂O₃ is a component that is located around a crystal nucleus and forms part of a core-shell structure. Once a core-shell structure is formed, a crystal nucleus component is less likely to be supplied from the outside of the shell, which makes it less likely that the crystal nuclei become enlarged and makes it likely that a large number of minute crystal nuclei are formed. Thus, it is possible to homogeneously precipitate fine crystals into the glass matrix. Furthermore, Al₂O₃ is also a component that increases the refractive index of the crystallized glass. The content of Al₂O₃ is preferably 15 to 35%, more preferably 20 to 30%, and particularly preferably 20 to 25%. If the content of Al₂O₃ is too small, the coefficient of thermal expansion tends to increase and, therefore, a crystallized glass having excellent thermal shock resistance is less likely to be obtained. In addition, the chemical durability tends to decrease. Furthermore, the crystal nuclei become large and accordingly coarse crystals are likely to be precipitated. On the other hand, if the content of Al₂O₃ is too large, the meltability of glass decreases and the viscosity of glass melt increases, which makes it difficult to clarify the glass and difficult to form the glass into shape and, therefore, makes it likely that the productivity decreases. In addition, mullite crystals tend to precipitate to devitrify the glass and, as a result, the crystallized glass becomes susceptible to breakage.

Li₂O is a component that largely influences the crystallinity. When Li₂O is incorporated into the glass, desired crystals, such as Li₂O—Al₂O₃—SiO₂-based crystals, are likely to be precipitated and precipitation of undesired crystals, such as mullite crystals, can be reduced. Li₂O is a component that reduces the viscosity of glass to increase the meltability and formability of the glass. In addition, Li₂O is a component that can easily decrease the refractive index of the crystallized glass. The content of Li₂O is preferably 0 to 4%, 1 to 4%, 2 to 4%, or 3 to 4%, and particularly preferably 3.5 to 4%. If the content of Li₂O is too large, the crystallinity becomes excessively high. Thus, the glass tends to be likely to devitrify and the crystallized glass becomes susceptible to breakage.

Na₂O is a component that can be incorporated into crystals of crystallized glass to form a solid solution together, and a component that largely influences the crystallinity and reduces the viscosity of glass to increase the meltability and formability of the glass. Furthermore, Na₂O is also a component for controlling the coefficient of thermal expansion and refractive index of crystallized glass. As the content of Na₂O increases, the refractive index of the crystallized glass is more likely to decrease. The content of Na₂O is preferably 0 to 6%, 0 to 5%, 0 to 4%, 0 to 3%, or 0 to 2%, and particularly preferably 0 to 1%. If the content of Na₂O is too large, the crystallinity becomes excessively high. Thus, the glass is likely to devitrify and the crystallized glass becomes susceptible to breakage. Furthermore, the ionic radius of a Na cation is large and, therefore, Na cations are relatively less likely to be incorporated into the crystals. Therefore, Na cations are likely to remain in the glass phase (glass matrix) even after crystallization. For this reason, if the content of Na₂O is too large, a refractive index difference between the crystalline phase and the remaining glass phase is likely to occur and, therefore, the crystallized glass tends to easily become excessively clouded. However, Na₂O is likely to be mixed as impurities into the glass. Therefore, if complete removal of Na₂O is pursued, the raw material batch tends to be expensive to increase the production cost. Therefore, from the viewpoint of reducing the increase in production cost, the lower limit of the content of Na₂O is preferably not less than 0.0003%, more preferably not less than 0.0005%, and particularly preferably not less than 0.001%.

K₂O is a component that can be incorporated into crystals of crystallized glass to form a solid solution together, and a component that largely influences the crystallinity and reduces the viscosity of glass to increase the meltability and formability of the glass. Furthermore, K₂O is also a component for controlling the coefficient of thermal expansion and refractive index of crystallized glass. As the content of K₂O increases, the refractive index of the crystallized glass is more likely to decrease. The content of K₂O is preferably 0 to 10%, 0 to 8%, 0 to 6%, 0 to 5%, 0 to 4%, 0 to 3%, or 0 to 2%, and particularly preferably 0 to 1%. If the content of K₂O is too large, the crystallinity becomes excessively high. Thus, the glass is likely to devitrify and the crystallized glass becomes susceptible to breakage. Furthermore, the ionic radius of a K cation is large and, therefore, K cations are relatively less likely to be incorporated into the crystals. Therefore, K cations are likely to remain in the glass phase (glass matrix) even after crystallization. For this reason, if the content of K₂O is too large, a refractive index difference between the crystalline phase and the remaining glass phase is likely to occur and, therefore, the crystallized glass tends to easily become excessively clouded. However, K₂O is likely to be mixed as impurities into the glass. Therefore, if complete removal of K₂O is pursued, the raw material batch tends to be expensive to increase the production cost. Therefore, from the viewpoint of reducing the increase in production cost, the lower limit of the content of K₂O is preferably not less than 0.0003%, more preferably not less than 0.0005%, and particularly preferably not less than 0.001%.

TiO₂ is a nucleating component for precipitating crystals in the crystallization process. On the other hand, if TiO₂ is much contained in glass, it significantly intensifies the coloration of the glass. Particularly, zirconia titanate-based crystals containing ZrO₂ and TiO₂ act as crystal nuclei, but electrons transition from the valence band of oxygen serving as a ligand to the conduction bands of zirconia and titanium serving as central metals (LMCT transition), which involves the coloration of crystallized glass. Furthermore, if titanium remains in the remaining glass phase after the crystallization, LMCT transition may occur from the valence band of the SiO₂ skeleton to the conduction band of tetravalent titanium in the remaining glass phase. In addition, d-d transition occurs in trivalent titanium in the remaining glass phase, which involves the coloration of the crystallized glass. In the case where titanium and iron coexist, coloration like ilmenite (FeTiO₃) develops. In another case, it is known that the coexistence of titanium and tin intensifies the yellowish coloration of glass. Therefore, the content of TiO₂ is preferably not more than 1.4%, not more than 1%, not more than 0.5%, or not more than 0.2%, and particularly preferably not more than 0.1%. The lower limit of the content of TiO₂ is not particularly limited and may be 0%. However, TiO₂ can be crystal nuclei as described above and, therefore, addition thereof to the glass creates a tendency of increased likelihood of precipitation of crystal nuclei in the crystallization process. In addition, TiO₂ is likely to be mixed as impurities into the glass. Therefore, if complete removal of TiO₂ is pursued, the raw material batch tends to be expensive to increase the production cost. For these reasons, the lower limit of the content of TiO₂ is preferably more than 0%, not less than 0.0003%, not less than 0.0005%, not less than 0.001%, or not less than 0.005%, and particularly preferably not less than 0.01%.

SnO₂ is a component acting as a fining agent. Furthermore, SnO₂ can also be a component for efficiently precipitating crystals in the crystallization process. Specifically, by incorporating SnO₂ into glass, crystal nuclei can be easily formed, which reduces excessive clouding due to precipitation of coarse crystals and, as a result, enables prevention of breakage of the glass. On the other hand, SnO₂ is also a component that, if much contained in glass, significantly intensifies the coloration of the glass. The content of SnO₂ is preferably not less than 0%, not less than 0.01%, not less than 0.1%, not less than 0.2%, or not less than 0.5%, and particularly preferably not less than 1%. If the content of SnO₂ is too large, the coloration of the crystallized glass may be intensified. In addition, the amount of SnO₂ evaporated during melting tends to increase to increase the environmental burden. Therefore, the content of SnO₂ is preferably not more than 3%, more preferably not more than 2%, and particularly preferably not more than 1.5%. Furthermore, when SnO₂ is added into glass, the refractive index of the remaining glass phase is likely to be high. Therefore, SnO₂ can also be used to control the semitransparency.

P₂O₅ is a component that suppresses the precipitation of coarse ZrO₂ crystals. If coarse ZrO₂ crystals are precipitated, the glass is likely to devitrify and becomes susceptible to breakage. The content of P₂O₅ is preferably not less than 0%, not less than 0.01%, not less than 0.1%, or not less than 0.2%, and particularly preferably not less than 0.3%. On the other hand, if the content of P₂O₅ is too large, crystallization is suppressed and, thus, a crystallized glass having a desired semitransparency is less likely to be obtained. Therefore, the content of P₂O₅ is preferably not more than 2%, more preferably not more than 1.5%, and particularly preferably not more than 1%.

ZrO₂ is a nucleating component for precipitating crystals in the crystallization process. The content of ZrO₂ is preferably not less than 0.5%, not less than 1%, not less than 1.5%, or not less than 2%, and particularly preferably 2.5%. If the content of ZrO₂ is too small, crystal nuclei may not be formed well and, thus, coarse crystals may precipitate to make crystallized glass excessively clouded and susceptible to breakage. On the other hand, the upper limit of the content of ZrO₂ is not particularly defined, but, an excessive large content of ZrO₂ makes it likely that coarse ZrO₂ crystals precipitate to make the glass devitrifiable and make the crystallized glass susceptible to breakage. Therefore, the content of ZrO₂ is preferably not more than 10%, not more than 8%, or not more than 6%, and particularly preferably not more than 4%. In addition, ZrO₂ is also a component that can easily increase the refractive index of the remaining glass phase and, therefore, can also be used to control the semitransparency.

As described previously, the ratio between ZrO₂, TiO₂ serving as nucleating components and P₂O₅ serving as a component that suppresses the precipitation of crystals has a significant effect on the process from nucleation to growth of a main crystal. In order to obtain a dense crystalline phase (precipitate fine crystals homogeneously), the value of P₂O₅/(ZrO₂+TiO₂) is, in terms of mass ratio, preferably not more than 0.4, not more than 0.38, not more than 0.36, not more than 0.34, or not more than 0.32, and particularly preferably not more than 0.3. The lower limit of the ratio is not particularly limited. However, if the ratio is too low, devitrification due to ZrO₂ is likely to occur and coarse ZrO₂ crystals are likely to be produced. Therefore, the ratio is preferably not less than 0.01, not less than 0.02, or not less than 0.05, and particularly preferably not less than 0.1.

The crystallized glass according to the present invention may contain, in addition to the above components, the following components.

Pt is a component that can be incorporated in a state of ions, colloid, metal or so on into glass and causes the glass to develop a yellowish to ginger coloration. Furthermore, this tendency is significant after crystallization. Therefore, the content of Pt is preferably not more than 7 ppm, not more than 6 ppm, not more than 5 ppm, not more than 4 ppm, not more than 3 ppm, not more than 2 ppm, not more than 1 ppm, not more than 0.9 ppm, not more than 0.8 ppm, not more than 0.7 ppm, not more than 0.6 ppm, not more than 0.5 ppm, or not more than 0.4 ppm, and particularly preferably not more than 0.3 ppm. Although the incorporation of Pt should be avoided as much as possible, there may be a case where, with the use of general melting facilities, Pt members need to be used in order to obtain a homogeneous glass. Therefore, if complete removal of Pt is pursued, the production cost tends to increase. In the absence of any adverse effect on the coloration of glass, in order to reduce the increase in production cost, the lower limit of the content of Pt is preferably not less than 0.0001 ppm, not less than 0.001 ppm, not less than 0.01 ppm, not less than 0.02 ppm, not less than 0.03 ppm, not less than 0.04 ppm, not less than 0.05 ppm, or not less than 0.06 ppm, and particularly preferably not less than 0.07 ppm. Furthermore, so long as the coloration is permitted, Pt may be used as a nucleating agent for promoting the precipitation of a main crystal, as with ZrO₂ or TiO₂. In doing so, Pt may be used alone as a nucleating agent or used as a nucleating agent in combination with another or other components. In using Pt as a nucleating agent, its form (colloid, metallic crystals or so on) is not particularly limited.

Rh is a component that can be incorporated in a state of ions, colloid, metal or so on into glass and tends to cause the glass to develop a yellowish to ginger coloration, like Pt. Therefore, the content of Rh is preferably not more than 7 ppm, not more than 6 ppm, not more than 5 ppm, not more than 4 ppm, not more than 3 ppm, not more than 2 ppm, not more than 1 ppm, not more than 0.9 ppm, not more than 0.8 ppm, not more than 0.7 ppm, not more than 0.6 ppm, not more than 0.5 ppm, or not more than 0.4 ppm, and particularly preferably not more than 0.3 ppm. Although the incorporation of Rh should be avoided as much as possible, there may be a case where, with the use of general melting facilities, Rh members need to be used in order to obtain a homogeneous glass. Therefore, if complete removal of Rh is pursued, the production cost tends to increase. In the absence of any adverse effect on coloration, in order to reduce the increase in production cost, the lower limit of the content of Rh is preferably not less than 0.0001 ppm, not less than 0.001 ppm, not less than 0.01 ppm, not less than 0.02 ppm, not less than 0.03 ppm, not less than 0.04 ppm, not less than 0.05 ppm, or not less than 0.06 ppm, and particularly preferably not less than 0.07 ppm. Furthermore, so long as the coloration is permitted, Rh may be used as a nucleating agent, as with ZrO₂ or TiO₂. In doing so, Rh may be used alone as a nucleating agent or used as a nucleating agent in combination with another or other components. In using Rh as a nucleating agent that promotes precipitation of a main crystal, its form (colloid, metallic crystals or so on) is not particularly limited.

Furthermore, for the above reasons, Pt+Rh is preferably not more than 7 ppm, not more than 6 ppm, not more than 5 ppm, not more than 4 ppm, not more than 3 ppm, not more than 2 ppm, not more than 1 ppm, not more than 0.9 ppm, not more than 0.8 ppm, not more than 0.7 ppm, not more than 0.6 ppm, not more than 0.5 ppm, or not more than 0.4 ppm, and particularly preferably not more than 0.3 ppm. Although the incorporation of Pt and Rh should be avoided as much as possible, there may be a case where, with the use of general melting facilities, Pt members and Rh members need to be used in order to obtain a homogeneous glass. Therefore, if complete removal of Pt and Rh is pursued, the production cost tends to increase. In the absence of any adverse effect on coloration, in order to reduce the increase in production cost, the lower limit of Pt+Rh is preferably not less than 0.0001 ppm, not less than 0.001 ppm, not less than 0.01 ppm, not less than 0.02 ppm, not less than 0.03 ppm, not less than 0.04 ppm, not less than 0.05 ppm, or not less than 0.06 ppm, and particularly preferably not less than 0.07 ppm.

MoO₃ is an element that, in minute amounts, has an effect on crystallization and the color of the crystallized glass. In the case of Li₂O—Al₂O₃—SiO₂ crystallized glass, MoO₃ can be considered to have the effect of reducing the precipitation of β-spodumene solid solution likely to be coarse crystals. Therefore, MoO₃ can be added in minute amounts in order to make it easier to return a semitransparent product to a transparent product. The content of MoO₃ is preferably not less than 0%, more than 0%, more than 0.1 ppm, or more than 0.2 ppm, and particularly preferably not less than 0.3 ppm. On the other hand, if MoO₃ is excessively added, the crystallized glass may be colored to impair the design quality. Therefore, the content of MoO₃ is preferably not more than 100 ppm, not more than 80 ppm, not more than 60 ppm, or not more than 40 ppm, and particularly preferably not more than 20 ppm.

An As component (such as As₂O₃) and a Pb component (such as PbO) are components that function as an fining agent or a nucleating agent, but are highly toxic and may contaminate the environment, for example, during the production process of glass or during treatment of waste glass. Therefore, the content of each of As₂O₃ and PbO is preferably not more than 2%, not more than 1%, not more than 0.7%, less than 0.7%, not more than 0.6%, not more than 0.5%, not more than 0.4%, not more than 0.3%, not more than 0.2%, or not more than 0.1%, and the glass is particularly preferably substantially free of these components.

In the absence of any adverse effect on semitransparency, the crystallized glass according to the present invention may contain SO₃, MnO, Cl₂, Y₂O₃, La₂O₃, WO₃, HfO₂, Ta₂O₅, Nd₂O₃, Nb₂O₅, RfO₂, and so on up to 10% in total. However, the raw materials of these components are expensive and, thus, the production cost tends to increase. Therefore, these components may not be incorporated into glass unless the circumstances are exceptional. Particularly, HfO₂ is high in raw material cost and Ta₂O₅ may become a conflict mineral. Therefore, the total content of these components is, in terms of % by mass, preferably not more than 5%, not more than 4%, not more than 3%, not more than 2%, not more than 1%, not more than 0.5%, not more than 0.4%, not more than 0.3%, not more than 0.2%, not more than 0.1%, not more than 0.05%, less than 0.05%, not more than 0.049%, not more than 0.048%, not more than 0.047%, or not more than 0.046%, and particularly preferably not more than 0.045%.

In the absence of any adverse effect on semitransparency, the crystallized glass according to the present invention may contain, in addition to the above components, minor components, including H₂, CO₂, CO, H₂O, He, Ne, Ar, and N₂, each up to 0.1%. Furthermore, when Ag, Au, Pd, Ir, V, Cr, Sc, Ce, Pr, Pm, Sm, Eu, Gd, Tb, Dy, Ho, Er, Tm, Yb, Lu, Ac, Th, Pa, U, and so on are deliberately incorporated into glass, the raw material cost tends to increase. Meanwhile, when glass containing Ag, Au or so on is subjected to light irradiation or heat treatment, agglomerates of these components are formed and crystallization can be promoted based on these agglomerates. Moreover, Pd and so on have various catalytic actions. When glass contains these components, the crystallized glass can be given specific functions. In view of the above circumstances, when the aim is to give the function of promoting crystallization or other functions, the above components may be each contained preferably 1% or less, 0.5% or less, or 0.3% or less, and particularly preferably 0.1% or less. Otherwise, the content of each of the above components is preferably not more than 500 ppm, not more than 300 ppm, or not more than 100 ppm, and particularly preferably not more than 10 ppm.

β-OH, which is an index showing the amount of water in glass, has a significant effect on the process of crystallization. If β-OH is too high, excessive growth of crystals is promoted, which may make it difficult to return a semitransparent product to a transparent product by heat treatment. The reasons why β-OH promotes the growth of crystals are not clear, but one reason can be assumed that β-OH weakens the binding of the glass network to thus decrease the viscosity of the glass. The preferred range of values of β-OH is 0 to 2 mm⁻¹, 0.1 to 1.5 mm⁻¹, 0.15 to 1 mm⁻¹, or 0.18 to 0.5 mm⁻¹, and particularly preferably 0.2 to 0.4 mm⁻¹. By appropriately controlling, like the relationship of P₂O₅ with ZrO₂ and TiO₂, the relationship of β-OH with ZrO₂ and TiO₂, a dense crystalline phase can be obtained. Specifically, the ratio β-OH/(ZrO₂+TiO₂) is preferably not more than 0.14, not more than 0.13, not more than 0.12, or not more than 0.11, and particularly preferably not more than 0.105. The lower limit thereof is not particularly limited and may be 0, but is actually not less than 0.01.

β-OH changes depending on the raw material used, the melting atmosphere, the melting temperature, the melting time, and so on and, therefore, can be controlled by changing these conditions as necessary. For example, β-OH can be increased by increasing the amount of hydroxide in the raw material, melting the raw material by heating it with a burner or increasing the melting temperature. Alternatively, β-OH can be increased by lengthening the melting time under a sealed condition or shortening the melting time under an unsealed condition.

The crystallized glass according to the present invention can be produced by preparing a precursor glass before being crystallized and subjecting the precursor glass to heat treatment to crystallize it. The precursor glass can be obtained by melting a raw material batch formulated to provide a desired glass composition, for example, at 1500 to 1700° C. and forming the obtained molten glass into shape. The shape of the precursor glass is not particularly limited, but is normally a plate-like shape. The precursor glass is preferably amorphous, but crystals may be partly precipitated therein.

When, in the crystallization process of the precursor glass, the precursor glass is subjected to heat treatment at relatively low temperature, this provides the advantage that the progress of crystallization becomes slow, excessively large crystals are less likely to be precipitated, and excessive precipitation of undesirable crystals can be suppressed. In addition, performing heat treatment at relatively low temperature is preferred also from the viewpoint of enabling energy consumption and damage to a firing furnace to be reduced. Specifically, the heat treatment temperature (the maximum temperature of a temperature profile in the crystallization process) is, relative to the glass transition point Tg of the precursor glass, preferably not more than +200° C., not more than +180° C., not more than +160° C., not more than +155° C., not more than +150° C., or not more than +145° C., and particularly preferably not more than +140° C. If the heat treatment temperature is too low, desired crystals are less likely to be produced. In addition, it takes too long for the precursor glass to crystallize, which may result in increased energy consumption compared to the case where the precursor glass is fired at high temperature. Therefore, the heat treatment temperature (the maximum temperature of the temperature profile in the crystallization process) is, relative to the glass transition point Tg of the precursor glass, preferably not less than +60° C., not less than +65° C., not less than +70° C., or not less than +75° C., and particularly preferably not less than 80° C.

The heat treatment time is, for example, preferably 0.1 to 100 hours, more preferably 0.5 to 60 hours, and particularly preferably 1 to 40 hours. If the heat treatment time is too short, desired crystals are less likely to be produced. On the other hand, if the heat treatment time is too long, crystallization excessively progresses, which may make the glass transparent or excessively clouded, resulting in failure to obtain a desired semitransparent product.

Depending on the crystallization process, prior to holding of the precursor glass at the maximum temperature for a certain time, the precursor glass may be held at a lower temperature for a certain time to promote precipitation of crystal nuclei (a crystal nuclei formation process). By doing so, a dense crystalline phase can be easily obtained. The temperature in this crystal nuclei formation process is, relative to the glass transition point Tg of the precursor glass, preferably not less than +10° C., more preferably not less than +20° C., particularly preferably not less than +30° C., preferably not more than +80° C., more preferably not more than +70° C., and particularly preferably not more than +60° C. The time for the crystal nuclei formation process is preferably 0.1 to 30 hours, more preferably 0.5 to 15 hours, and particularly preferably 1 to 10 hours. By doing so, crystal nuclei can be sufficiently formed in the glass.

### EXAMPLES

Hereinafter, the present invention will be described with reference to examples, but the present invention is not limited to the following examples.

Table 1 shows the composition and characteristics of glass produced in an example. Tables 2 to 4 show Examples (Nos. 1 to 12).

TABLE 1

| | | unit | |
|---|---|---|---|
| Glass | SiO₂ | % by | 67.9 |
| Composition | Al₂O₃ | mass | 22.2 |
| | Li₂O | | 3.7 |
| | Na₂O | | 0.69 |
| | SnO₂ | | 1.1 |
| | P₂O₅ | | 0.39 |
| | MgO | | 1.3 |
| | BaO | | 0.01 |
| | Fe₂O₃ | | 0.01 |
| | ZrO₂ | | 2.7 |
| | MoO₃ | ppm | 0.3 |
| | P₂O₅/(ZrO₂ + TiO₂) | — | 0.14 |

| | | |
|---|---|---|
| β-OH | mm⁻¹ | 0.27 |
| β-OH/(ZrO₂ + TiO₂) | — | 0.1 |
| Glass transition point | ° C. | 727 |

TABLE 2

| | | unit | No. 1 | No. 2 | No. 3 | No. 4 | No. 5 |
|---|---|---|---|---|---|---|---|
| Average haze | | % | 7.4 | 19.4 | 22.2 | 14.8 | 7.8 |
| Maximum haze | | | 30.2 | 70.3 | 71.6 | 57.7 | 37.7 |
| Minimum haze | | | 1.1 | 2.1 | 2.2 | 1.5 | 0.6 |
| Heat | First | ° C. | 780 | 780 | 780 | 790 | 780 |
| treatment | temperature | | | | | | |
| conditons | First time | hours | 3 | 3 | 3 | 3 | 3 |
| | Second | ° C. | 800 | 800 | 800 | 810 | 860 |
| | temperature | | | | | | |
| | Second time | hours | 8 | 12 | 24 | 16 | 0.5 |

| | | | | | | |
|---|---|---|---|---|---|---|
| Type of crystals | — | ZrO₂, | ZrO₂, | ZrO₂, | ZrO₂, | ZrO₂, |
| | | β-Q | β-Q, β-S | β-Q, β-S | β-Q, β-S | β-Q, β-S |
| Average crystallite size | nm | 38 | 43 | 42 | 42 | 40 |
| Crystallinity | % | 6 | 40 | 53 | 55 | 60 |
| Refractive index nd | — | 1.517 | 1.524 | 1.525 | 1.526 | 1.527 |
| Density | g/cm³ | 2.4331 | 2.4657 | 2.4799 | 2.4802 | 2.4838 |

TABLE 3

| | | unit | No.6 | No.7 | No.8 | No.9 | No.10 |
|---|---|---|---|---|---|---|---|
| Average haze | | | 4.2 | 2.4 | 1.4 | 1.8 | 0.5 |
| Maximum haze | | % | 18.4 | 9.5 | 5.6 | 6.7 | 1.9 |
| Minimum haze | | | 0.7 | 0.4 | 0.2 | 0.4 | 0.2 |
| Heat | First | ° C. | 780 | 780 | 780 | 750 | 780 |
| treatment | temperature | | | | | | |
| conditions | First time | hours | 3 | 3 | 3 | 3 | 3 |
| | Second | ° C. | 860 | 815 | 845 | 860 | 860 |
| | temperature | | | | | | |
| | Second time | hours | 1 | 12 | 3 | 3 | 5 |

| | | | | | | |
|---|---|---|---|---|---|---|
| Type of crystals | — | ZrO₂, | ZrO₂, | ZrO₂, | ZrO₂, | ZrO₂, |
| | | β-Q, β-S | β-Q, β-S | β-Q, β-S | β-Q, β-S | β-Q, β-S |
| Average crystallite size | nm | 41 | 43 | 42 | 43 | 44 |
| Crystallinity | % | 70 | 75 | 80 | 80 | 85 |
| Refractive index nd | — | 1.53 | 1.531 | 1.532 | 1.532 | 1.533 |
| Density | g/cm³ | 2.4945 | 2.4981 | 2.5036 | 2.504 | 2.5096 |

TABLE 4

| | | unit | No. 11 | No. 12 |
|---|---|---|---|---|
| Average haze | | % | 0.7 | 1.6 |
| Maximum haze | | | 2.6 | 5.1 |
| Minimum haze | | | 0.2 | 0.6 |
| Heat | First | ° C. | 780 | 780 |
| treatment | temperature | | | |
| conditions | First time | hours | 3 | 4 |
| | Second | ° C. | 890 | 920 |
| | temperature | | | |
| | Second time | hours | 1 | 1 |

| | | | |
|---|---|---|---|
| Type of crystals | — | ZrO₂, β-Q, β-S | ZrO₂, β-Q, β-S |
| Average crystallite size | nm | 44 | 50 |
| Crystallinity | % | 85 | 90 |
| Refractive index nd | — | 1.533 | 1.533 |
| Density | g/cm³ | 2.5072 | 2.5123 |

### Example 1

Raw materials were formulated in the form of an oxide, a hydroxide, a carbonate, a nitrate or other forms to provide a glass having the composition shown in Table 1, thus obtaining a glass batch. The obtained glass batch was melted at 1500 to 1700° C. and roll formed to a thickness of 4 to 5 mm, thus obtaining glass samples (precursor glasses). The composition shown in Table 1 is analysis values of a glass sample actually produced by the following method. The melting was performed using a melting furnace commonly used for glass production.

The respective contents of Pt and Rh in the glass sample were analyzed in the following manner. First, the produced glass sample was ground and wetted with pure water and, then, perchloric acid, nitric acid, sulfuric acid, hydrofluoric acid or the like was added to the glass sample to dissolve the glass sample with the acid. The obtained solution was measured in terms of respective contents of Pt and Rh in the glass sample with an ICP-MS (inductively coupled plasma mass spectrometry) instrument (Agilent 8800 manufactured by Agilent Technologies, Inc.). Based on calibration curves made using prepared Pt and Rh solutions the concentrations of which had been known, the measurement was performed. The measurement modes were a He gas/HMI (low mode) for Pt and a HEHe gas/HMI (middle mode) for Rh. The mass numbers were 198 for Pt and 103 for Rh.

The content of Li₂O in the glass sample was analyzed with an atomic absorption spectrometer (contrAA 600 manufactured by Analytik Jena). The manner of the analysis for this component was fundamentally the same as the analysis for Pt and Rh, such as the method for dissolving the glass sample and the use of the calibration curve.

With respect to the other components, the content of each component was measured with ICP-MS or atomic absorption spectrometry, like Pt, Rh, and Li₂O, or otherwise a calibration curve was made with an XRF (X-ray fluorescence) analyzer (ZSX Primus IV manufactured by Rigaku Corporation) using as a sample for determining the calibration curve a glass sample the concentration of which had been known by previously examining it with an ICP-MS or atomic absorption spectrometer and the content of the component was determined from an XRF analysis value of the measurement sample based on the calibration curve. In doing XRF analysis, the tube voltage, the tube current, the exposure time, and so on were adjusted according to the analytical component as needed.

The glass transition point was evaluated, using a glass sample processed with a length of 20 mm and a diameter of 3.8 mm, by measuring its thermal expansion curve and calculating an inflection point of the curve. A dilatometer manufactured by NETZSCH was used for the measurement.

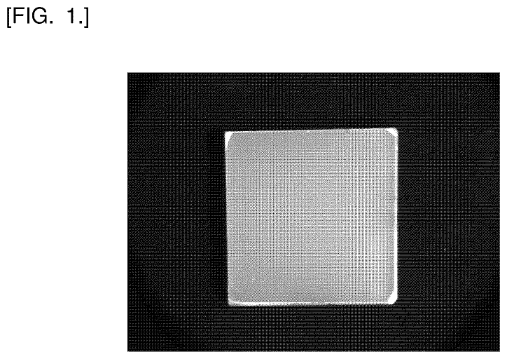

The obtained glass samples were subjected to heat treatment under conditions shown in Tables 2 to 4. Specifically, each of the glass samples was subjected to heat treatment at the first temperature for the first time as shown in Tables 2 to 4, then further subjected to heat treatment at the second temperature for the second time to grow crystals, and thus crystallized. Thereafter, the glass sample was cooled to room temperature at 400° C./h. In this manner, crystallized glass samples were obtained. The obtained samples were evaluated in terms of β-OH value, haze, type of precipitated crystals, crystallite size of the main crystal, crystallinity, refractive index (nd), and density. A photograph of a crystallized glass sample No. 3 is shown in FIG. 1.

β-OH was determined by measuring transmittances of glass with FT-IR Frontier (manufactured by PerkinElmer Inc.) and using the equation described previously. In the measurement, the scan speed was 100 μm/min, the sampling pitch was 1 cm⁻¹, and the scan times were five per measurement.

Regarding the haze, the total light transmittance and the diffused transmittance were measured by the following method and the haze was calculated from the obtained transmittance data. Each of the transmittances was evaluated by measuring a crystallized glass sheet (30 mm square) optically polished at both sides to have a thickness of 4 mm with a spectro-photometer. A spectro-photometer V-670 manufactured by JASCO Corporation was used for the measurement. The spectro-photometer V-670 was fitted with an integrating sphere unit “ISN-723” and, therefore, the measured transmittance corresponds to the total light transmittance. Furthermore, the measurement wavelength range was 380 to 780 nm, the scan speed was 200 nm/min, the sampling pitch was 1 nm, and the band width was 5 nm. Prior to the measurement, a baseline correction (adjustment to 100%) and a dark measurement (adjustment to 0%) were performed. The dark measurement was conducted in a state where a barium sulfate plate attached to ISN-723 was removed. The diffused transmittance of the crystallized glass was measured, using the same type of instrument as for the total light transmittance, by putting a measurement sample in place in a state where a barium sulfate plate attached to ISN-723 was removed.

The precipitated crystals were evaluated with an X-ray diffractometer (a tabletop X-ray diffractometer Aeris manufactured by Malvern Panalytical). The measurement range was 5 to 60°, the measurement step was 0.01°, and the scan speed was 1.5°/min. Using analysis software, the type of main crystal was identified and the average particle diameter was evaluated. A β-quartz solid solution and a β-spodumene solid solution, each of which is the type of precipitated crystals identified as a main crystal, are shown as “β-Q”, and “β-S”, respectively, in the tables. The average particle diameter of the main crystal was calculated using a measured X-ray diffraction peak based on the Debeye-Sherrer method. The crystallinity was determined from the integrated intensity ratio between the amorphous peak and the crystal peak.

The refractive index was measured with a precision refractometer using a 4 mm thick crystallized glass sheet (30 mm square). A Kalnew precision refractometer KPR-2000 manufactured by Shimadzu Corporation was used for the measurement. The measurement was performed by the V-block method, wherein the above crystallized glass sheet polished to have a right angle between two surfaces was placed on a prism of the refractometer and the refractive index in terms of d-line (587.6 nm) was measured. In order to reduce light scattering between the prism surface and the sample surface to increase the measurement accuracy, the measurement was conducted in a state where an immersion liquid having a refractive index nd of 1.53 was interposed between the prism and the sample.

The density was evaluated by the Archimedes' method.

As shown in Tables 2 to 4, in all the crystallized glasses Nos. 1 to 12 being examples of the present invention, the average particle diameter of the main crystal was 100 nm or less and the average haze was 0.5 to 22.2%, both of which satisfied desired characteristics. For example, as shown in FIG. 1, in the crystallized glass No. 3, crystals having an average crystal size of 43 nm obviously smaller than those of the crystallized glasses in the above-described Patent Literatures were precipitated. However, the crystallized glass exhibited a semitransparent appearance in which the average haze was 22.2%. In addition, it was confirmed that by heating the crystallized glass at 860° C. again, the haze was decreased and the average haze at wavelengths of 380 to 780 nm changed to less than 0.5%.

1. A crystallized glass having an average haze of more than 0 to 30% at wavelengths of 380 to 780 nm in terms of a thickness of 4 mm and having a main crystal with an average particle diameter of 1 to 100 nm.

2. The crystallized glass according to claim 1, containing, in terms of % by mass, the following components:
45 to 75% SiO₂;
15 to 35% Al₂O₃;
0 to 4% Li₂O;
0 to 6% Na₂O;
0 to 10% K₂O;
0 to 1.4% TiO₂;
0 to 3% SnO₂;
0 to 2% P₂O₅;
0.5% or more ZrO₂; and
P₂O₅/(ZrO₂+TiO₂)≤0.4.

3. The crystallized glass according to claim 1, wherein a value of β-OH [mm⁻¹] and a total content of ZrO₂ and TiO₂ in terms of % by mass satisfy β-OH/(ZrO₂+TiO₂)≤0.14.

4. The crystallized glass according to claim 1, wherein Pt+Rh is less than 7 ppm.

5. The crystallized glass according to claim 1, wherein a content of MoO₃ is more than 0%.

6. The crystallized glass according to claim 1, being substantially free of As component and Pb component.

7. The crystallized glass according to claim 1, having a crystallinity of 1 to 99%.

8. The crystallized glass according to claim 1, wherein at least one selected from among a β-quartz solid solution, a β-spodumene solid solution, and zirconia is precipitated.

9. A method for manufacturing the crystallized glass according to claim 1, the method comprising the steps of:
preparing a precursor glass; and
subjecting the precursor glass to heat treatment at a temperature of not more than +200° C. relative to a glass transition point of the precursor glass to crystallize the precursor glass.
